(19) United States
(12) Patent Application Publication
(10) Pub. No.: US 2004/0089978 A1
(43) Pub. Date: May 13, 2004

(54) Apparatus and method for rotary embossing hollow profile structures

(76) Inventors: Thomas W. Zimmerman, West Henrietta, NY (US); Roger Bessette, Webster, NY (US); Thomas Greenberg, Bergen, NY (US)

Correspondence Address: William B. Ritchie, The Ritchie Law Office, 43 Jackson Street, Concord, NH, 03301, US

(21) Appl. No.: 10/292,748

(22) Filed: Nov. 12, 2002

(51) Int. Cl. B29C 59/04

(52) U.S. Cl. 264/284; 425/363

(57) ABSTRACT

A rotary embossing method and apparatus for use on hollow profiles having a predetermined dimension and number of sides, the embossing method includes the following steps. First, placing at lease one internal support having a predetermined dimension inside the hollow profile, and second, embossing the hollow profile on at least one of the predetermined number of sides using a rotary embosser. In alternate embodiments, the embossing method further includes the step of heating or cooling the rotary embosser, and the addition of connection means that are fixably attached to the internal support and to an extrusion die, whereby the connection means allow for continuous rotary embossing of the hollow profiles.

### FIELD OF THE INVENTION

The present invention relates to the field of embossing and, in particular, to an apparatus and method for rotary embossing hollow profiles.

### BACKGROUND OF THE INVENTION

The current art to manufacture hollow shapes that have external texture is by molding methods that are well known in the art. Typically, such hollow structures are extruded in a continuously fed extrusion line wherein the desired lengths are later cut to size. The types of the materials that can be extruded range from polymeric materials such as polyvinyl chloride, TEFLON, polypropylene, polyethylene, and urethane, to metals such as steel, stainless steel, brass, copper, zinc, titanium and other alloys of the aforementioned metals.

Many industrial materials are embossed to improve appearance or for other functional reasons such as slip resistance, strength, reflectivity or heat transfer. During the embossing process a material or structure is typically passed between two rolls, with one or more having a surface texture. At the nip of the rollers a gap is controlled dimensionally and the material is subjected to pressure or temperature or both such that the rollers impart forces that exceed the material yield strength, which permanently deforms and textures the material. Generally on flat/solid material, enough pressure can be used to transfer the pattern without destroying its shape. On hollow core surfaces, the pressure required to emboss often exceeds the structural integrity of the profile, causing yielding of the overall shape.

Therefore, while current methods exist to emboss flat materials, no known method exists to emboss hollow profiles without deforming the hollow structure, especially extruded hollow structures produced in a continuously fed extrusion line. The forces necessary to impact sufficient plastic deformation to the surface to create quality texture usually lead to distortion of the required shape produced.

Therefore, there is a need for an industrial embossing apparatus and method that embosses hollow core structures without deforming the hollow structure.

### SUMMARY OF THE INVENTION

In accordance with one aspect of the present invention, a rotary embossing apparatus for use on hollow structures having a predetermined cross-sectional profile and at least one embossing surface is provided. The embossing apparatus and method includes the following steps: 1) Placing at lease one internal support having a predetermined cross-sectional profile inside the hollow structure, and 2) embossing the hollow profile on at least one of the predetermined number of sides using a rotary embosser.

Implementation of this aspect of the present invention may include one or more of the following: 1) having the predetermined dimension of the internal support corresponds to the dimension of the hollow profile; 2) an internal support having at least one roller. The embossing method further includes the step of heating or cooling the rotary embosser.

Connection means are fixably attached to the internal support and to an extrusion die, whereby the connection means allow for continuous rotary embossing of the hollow profiles. The connection means are at least one magnet, the connection means are at least one cable, the connection means are at least one rod, the connection means are at least one cable and at least one rod, the connection means are at least one cable, at least one rod, and at least one magnet, the connection means are at least one cable and at least one magnet, and the connection means are at least one rod and at least one magnet.

These aspects of the invention are not meant to be exclusive and other features, aspects, and advantages of the present invention will be readily apparent to those of ordinary skill in the art when read in conjunction with the following description, appended claims and accompanying drawings.

### BRIEF DESCRIPTION OF THE DRAWINGS

FIG. 1 is a front view of the preferred embodiment of the backing block, with connection means attached, used in the present invention.

FIG. 2 is a front view of one embodiment of the backing block used in the present invention where the backing block includes rollers.

FIG. 3 is a view of the hollow profile structure exit position of an extruding die.

FIG. 4 is a view of the backing blocks within the hollow profile.

FIG. 5 is an entrance view of the embossing process according to the preferred embodiment of the present invention.

FIG. 6 is the exit view of the embossing process according to the preferred embodiment of the present invention.

### DETAILED DESCRIPTION OF THE INVENTION

The present invention is a method and an apparatus for embossing hollow profiles in a continuously fed production process, utilizing existing manufacturing processes on extrusion lines, without altering the hollow profile's overall dimensions or integrity. The present invention utilizes a backing block structure which is designed to be placed inside the hollow profile. The backing block provides the counter pressure required in order to emboss the surface of the hollow profile without destroying the profile's overall dimensions. Cables or rods, or both, attached to the backing block, are attached at the opposing end to the extrusion die, and run through the middle of the hollow portions of the hollow profile which is continuously being produced on a production line. Heating and cooling can be applied to the embossing rolls to modify the yield strength of the resultant embossed hollow profile.

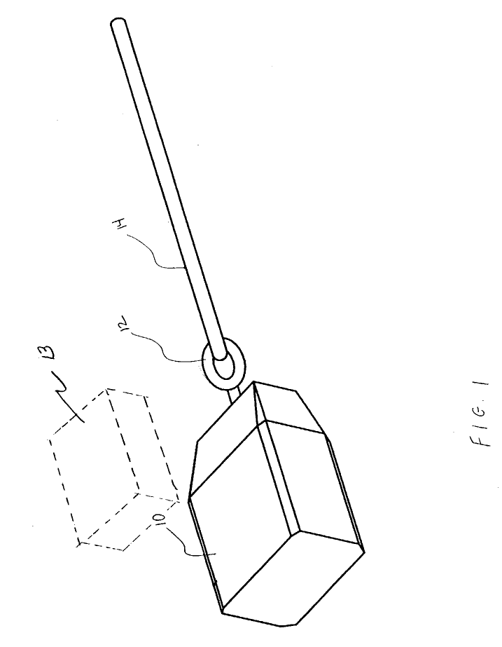

Referring first to FIG. 1, the preferred embodiment of the backing block 10 is shown. The backing block 10 is placed inside the hollow profile meant for embossing, and therefore has external dimensions that match the inner profile of the hollow profile. Thus, although in FIG. 1 the backing block 10 is depicted as rectangular in shape, in other embodiments, the backing block 10 matches the shape of the hollow profile to be embossed. These alternate shapes include conical, circular, cubical, cylindrical, hexagonal, octagonal, and any other shape know in the art. Backing blocks 10 are therefore made specifically for use in the embossing of particular hollow profiles.

In the preferred embodiment, the backing block 10 is made from steel. In other embodiments, the backing block 10 is made from stainless steel, iron, titanium, brass copper, zinc or any other material of similar properties known in the art.

A connection means is attached to the backing block 10. In one embodiment, the connection means is a cable 14 and/or a rod 12 which are attached to the backing block 10. The cable 14, rod 12 or combination of both a cable 14 and a rod 14 hold the backing block 10 in position during the embossing process. In some embodiments, multiple cables 14 or rods 12 are used to hold one backing block 10 in place. The cables 14 and rods 12 are attached, on the opposite ends, to the inner profile of the extrusion die located upstream in the rotary embossing process. In alternate embodiments, the connection means are at least one magnet 13, which are used in lieu of cables 14 and/or rods 12 to hold the backing block 10 in position. In other embodiments, the connection means are at least one cable, at least one rod and at least one magnet, used in combination

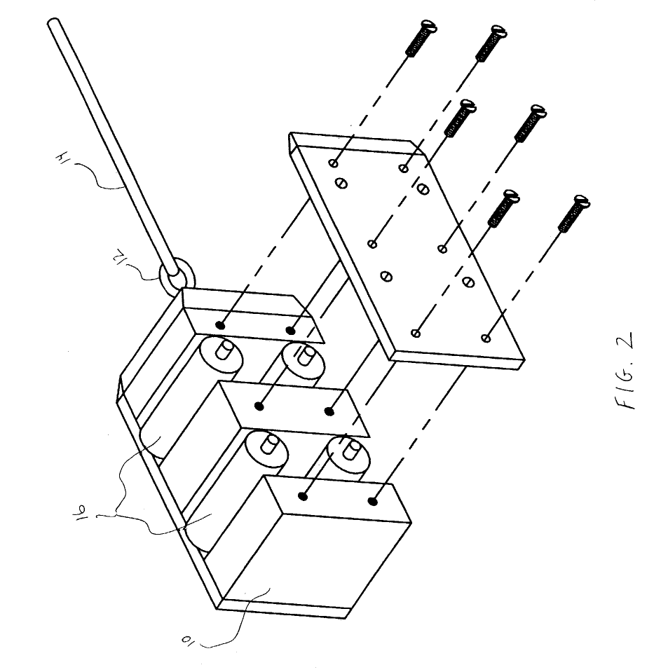

Referring next to FIG. 2, an alternate embodiment of the backing block is shown. In this embodiment, the backing block 10 includes the addition of rollers 16 within the backing block 10 to reduce the surface friction between the backing block 10 and the hollow profile (not shown). In the preferred embodiment, the backing block 10 includes 4 rollers 16, but in other embodiments, the backing block 10 includes any number of rollers 16. In some embodiments, the rollers 16 are textured to impart balancing strains and embossing of the internal surface of the hollow profile. The balanced embossing reduces internal stresses that develop in thin walled structures. In the preferred embodiment, the rollers 16 are made from steel, but in other embodiments the rollers are made from stainless steel, iron, titanium, brass, copper, zinc or any other material of having similar properties known and used in the art.

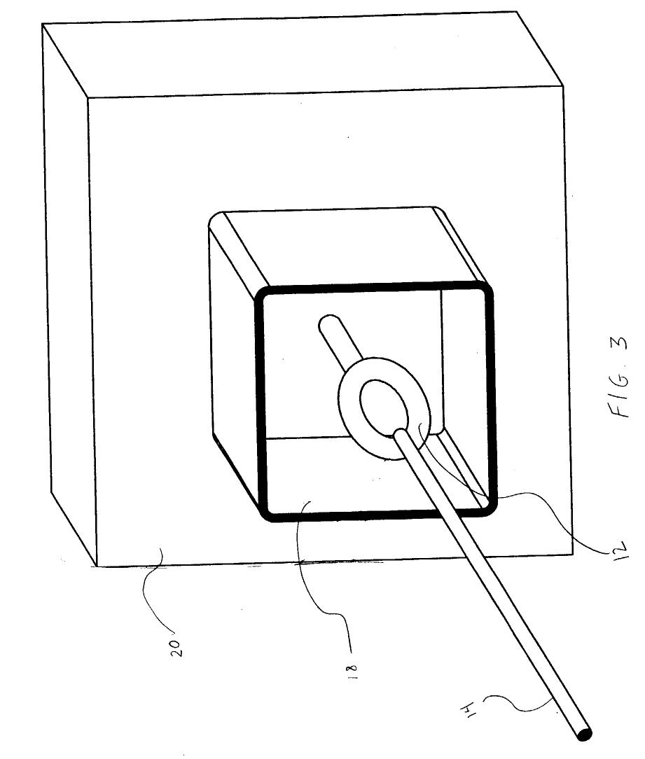

Referring now to FIG. 3, a view of the hollow profile exit portion of an extruding die and how the cables 14 and or rods 12 are attached to maintain the backing block (not shown) in position is shown. The cable 14 extends in the downstream direction, through the middle of the hollow profile structure 18. The cables 14 and/or rods 12 are attached to the backing block as represented in FIG. 1.

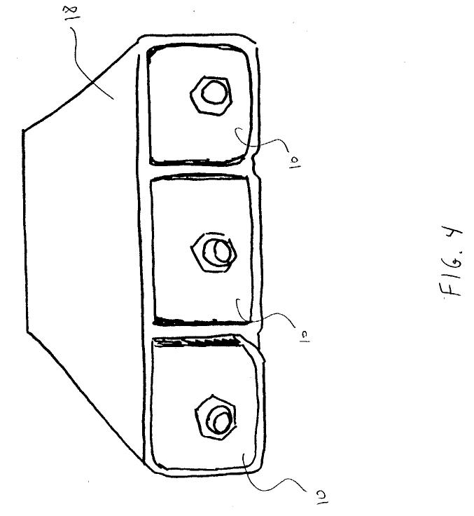

Referring now to FIG. 4, the shape and positioning of the backing block 10 within the hollow profile structure 18 is shown. FIG. 4 exemplifies how the backing block 10, roller shape (not shown) and dimensions vary dependent upon the hollow profile. In this FIG., the hollow profile includes three distinct hollow compartments; therefore, three backing blocks 10 are used in order for the hollow profile to be successfully embossed without loss of integrity. The hollow profile can be made of a wide range of materials including thermoplastics or other polymeric material that can be extruded and embossed. These include: PVC, nylon, Teflon, polypropylene, polyethylene and other material known in the art. The hollow profiles can also be made from a wide range of metals, including: steel, stainless steel, brass, copper, zinc, titanium, or other metals known in the art.

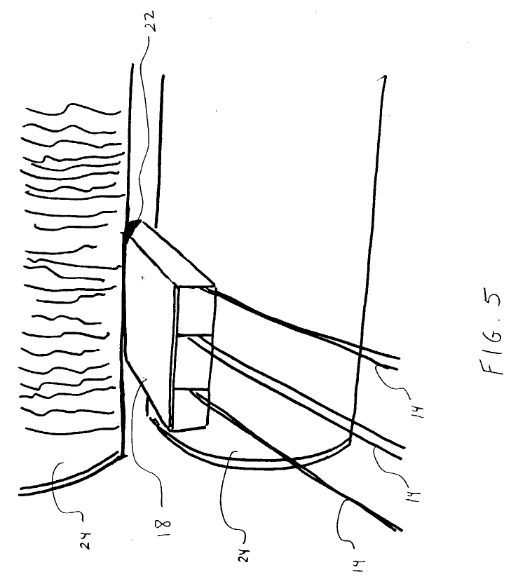

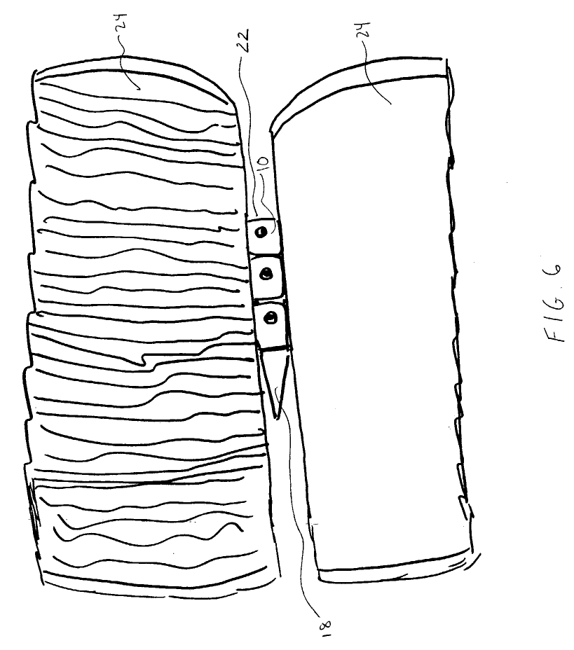

The embossing process works as follows. Backing blocks are placed inside the hollow profile structure at key points. These key points are determined by the user and are related to the hollow profile structure design. The hollow profile is then embossed. Referring now to FIG. 5, the hollow profile 18 is formed at the extrusion die and exits with the positioning cables 14 running downstream within the hollow profile 18. The downstream ends of the cables 14 are attached to the backing blocks (not shown) positioned in the NIP position 22 formed by the embossing rolls 24 as shown in FIG. 6. FIG. 5 shows the hollow profiles as cut away to illustrate the process. In actual application, the cables 14 would not be visible because they run inside the structure on a continuous extrusion process. The hollow profile 18 in this FIG. is being driven away from the observer's perspective.

Referring now to FIG. 6, the exit view of the hollow profile 18 being embossed by the embossing rolls 24 with the backing blocks 10 positioned in the NIP point 22 is shown. The hollow profile structure 18 is being driven toward the observer by the embossing rolls 24. In some embodiments of the present invention, heating or cooling to the embossing rolls 24 is applied, as needed, to modify the yield strength of the resulting embossed hollow profile.

As a result of the embossing process, the hollow profile structure is embossed, having a pattern imparted on the surface of the hollow profile structure without alteration of its overall shape or dimensions. In other embodiments of this embossing process, the hollow profile structure is embossed on its bottom, particular sides, both, or bottom, top and all sides.

The blocks provide the counter pressure required in order to deform the surface of the hollow structure with embossing rolls without altering or destroying the overall hollow profile dimensions. The backing block prevents material that represents the wall thickness of the hollow profile from deflecting inward during embossing. With the required support, the embossing rolls transfer a pattern or texture into the hollow profile structure.

Although the present invention has been described in considerable detail with reference to certain preferred versions thereof, other versions would be readily apparent to those of ordinary skill in the art. Therefore, the spirit and scope of the appended claims should not be limited to the description of the preferred versions contained herein.

What is claimed is:

1. An embossing apparatus for use on a hollow structure having a predetermined cross-sectional profile with at least one external surface that is to be rotary embossed thereon by placing such hollow structure within the nip of the rollers of a rotary embossing machine and wherein the predetermined cross-sectional profile has at least one internal surface that is opposed to said at least one external surface, said apparatus comprising:
at lease one internal support having a predetermined cross-sectional profile that corresponds to the predetermined cross-sectional profile of said hollow structure that is to embossed by said rotary embossing machine; and
an attachment mechanism, attached to said at least one internal support, such that said at least one internal support is kept within the hollow structure at a location wherein said hollow structure is within the nip of the rollers such that said internal support block provides a sufficient backpressure against said at least one internal surface to allow the embossing of said at least one external surface without the cross-sectional profile of said hollow structure being substantially distorted as said hollow structure moves through said rotary embossing machine.

2. The embossing apparatus of claim 1 wherein said attachment mechanism further comprises a cable.

3. The embossing apparatus of claim 1 wherein said attachment mechanism further comprises a rod.

4. The embossing apparatus of claim 1 wherein said attachment mechanism further comprises a magnet.

5. The embossing apparatus of claim 1 wherein said at least one internal support further comprises at least one roller.

6. The embossing apparatus of claim 5 wherein said at least one roller is textured to correspond to the embossing that is being embossed on said at least one embossing surface of said hollow structure in order to impart balancing balance strains and embossing on said at least one internal surface of said hollow structure thus reducing internal stresses in the wall of said hollow structure.

7. A method for embossing at least one surface on a hollow structure having a predetermined cross-sectional profile with at least one external surface that is to be rotary embossed thereon by placing such hollow structure within the nip of the rollers of a rotary embossing machine and wherein the predetermined cross-sectional profile has at least one internal surface that is opposed to said at least one external surface, said method comprising the steps of:
positioning an internal support within said hollow structure such that said internal support has a cross-sectional profile that corresponds to the cross-sectional profile of said hollow structure; and
internally supporting the internal surface that is opposed to said at least one external surface of said hollow structure; and
moving said internal support within said hollow structure such that said at least internal surface is supported in a region opposite said at least one external surface when said at least one external surface is within the nip of the rollers of said rotary embossing machine; and
embossing a pattern onto said at least one said external surface such that the predetermined cross-sectional profile of said hollow structure is embossed without said hollow structure undergoing substantial distortion.

8. The method of claim 1 further comprising the step of:
heating the external surface of said hollow structure at least in the region wherein said hollow structure passes through the nip of the rollers of said rotary embossing machine.

9. The method of claim 1 further comprising the step of:
cooling the external surface of said hollow structure at least in the region wherein said hollow structure passes through the nip of the rollers of said rotary embossing machine.
